(19) United States
(12) Patent Application Publication
(10) Pub. No.: US 2015/0148947 A1
(43) Pub. Date: May 28, 2015

(54) Wireless Medication Monitor

(71) Applicants: Jason Thomas McConville, Albuquerque, NM (US); Michael Bernauer, Albuquerque, NM (US)

(72) Inventors: Jason Thomas McConville, Albuquerque, NM (US); Michael Bernauer, Albuquerque, NM (US)

(21) Appl. No.: 14/555,086

(22) Filed: Nov. 26, 2014

Related U.S. Application Data
(60) Provisional application No. 61/909,510, filed on Nov. 27, 2013.

(51) Int. Cl. G06F 19/00

(52) U.S. Cl. CPC G06F 19/3456
USPC 700/244

(57) ABSTRACT

Methods and apparatus are provided for determining when a medication is removed from a dispenser. The dispenser may include a plurality of compartments for receiving one or more medications. One or more circuits are associated with each compartment. In addition, each circuit may be unique. Each circuit is altered by the removal of one or more medications from a compartment and the resulting signal is used to indicate removal of the medication.

### RELATED APPLICATIONS

This application claims the benefit of U.S. Provisional Application No. 61/909510, filed Nov. 27 2013.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Medications are often dispensed by pharmacies and physicians for patients in blister packs and/or pill bottles. Once the medication is dispensed, the pharmacy and doctor do not have a method of ensuring that the medication is being taken properly per the doctor's instructions. A failure to adhere to prescribed dosing may be problematic for both the patient and the physician. Non-compliance may result in poor outcomes and inaccurate remedial actions.

Non-compliance is also often the result of unintentional error by the patient. For example, a patient may simply forget or lose track of time thereby failing to take the appropriate medication at the appropriate time.

In addition, there is a need to monitor the use and location of medications to prevent unauthorized uses and sales of the medication. This is especially true for medications such as opioids and stimulants, which are illegally sold for non-medical uses.

It is, therefore, desirable to provide a medication monitoring system to allow a pharmacy, physician and others responsible for monitoring the use and distribution of medications to remotely and accurately monitor when the medication is being removed from the packaging.

### BRIEF SUMMARY OF THE INVENTION

In one embodiment, an apparatus is disposed on a medication package for monitoring when the medication is removed from the package. In another embodiment, a medication dispenser is provided that has a plurality of compartments for receiving one or more medications.

An electrical circuit is associated with each compartment such that the electrical circuit is altered in response to the removal of one or more medications from a compartment. In addition, each compartment has one or more circuits assigned to it and the alteration to the circuit may be detected by the breaking of or to detected discontinuity in the electrical circuit.

In one embodiment, use is monitored by the increase in monitored voltage associated with the breaking of the circuit associated with a medication compartment. Each circuit may also have a different resistance, which permits the identification of the compartment from which the medication is removed.

A processor for monitoring the electrical circuits may be integrated into the container or connected to the container. The processor may also be configured to send reminders and notification of use, store and send a date stamp and/or time stamp of use, indicate tampering, and indicate location of use. In addition, the processor may have as unique identifier or circuit to identify the dispenser and confirm authenticity.

Another embodiment of the invention provides a method for monitoring the usage of a medication involving the steps of providing a container having a plurality of compartments for housing one or more medications. An electrical circuit is associated with each compartment and an alteration in the circuit indicates the removal of the medication. In addition, the circuit may have a unique con figuration to identify the dispenser and confirm authenticity.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a perspective view of one embodiment of the present invention.

FIG. 2 illustrates circuitry that may be used to detect the removal of a medication in some embodiments of the present invention.

FIGS. 3-5 illustrate circuitry that may be used to detect tampering.

FIG. 6 illustrates another embodiment of the present invention.

FIG. 7 illustrates the linear response of the circuit shown in FIG. 6.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

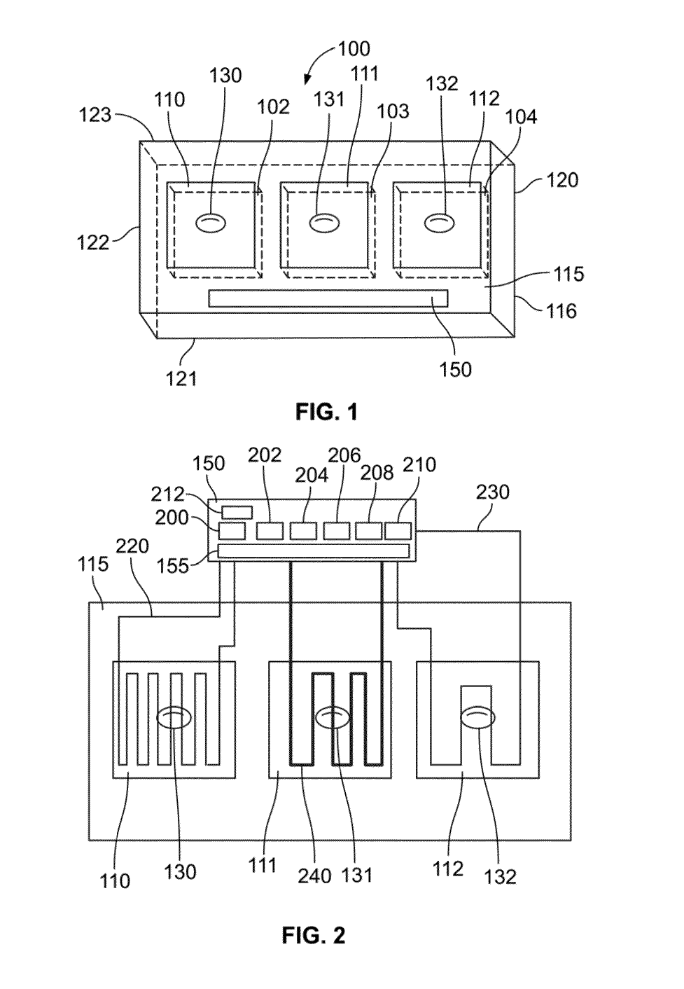

Embodiments of the present invention relate to a method and apparatus for monitoring a medication as it is removed from its packaging to determine therapy compliance and/or use in clinical trials. As shown in FIG. 1, the medication can be provided in packaging such as blister package 100 or in other containers in accordance with the below description of the preferred embodiments of the present invention.

As shown in FIG. 1, a dispenser container 100 may include a plurality of openings, bins or compartments 102-104 that are covered by layers, covers or panels 110-112 for storing medications 130-132. Covers 110-112 may constructed of a material that permits the cover to be removed, broken, or partially opened to permit access to the medication when desired while still providing protection when not accessed by a user.

In some embodiments, container 100 may also include a top surface 115 and opposingly located bottom surface 116 that are connected by walls 120-123. While a box-like configuration is illustrated as one example of the invention, other embodiments include other configurations and shapes, which allow for the storage of medications and the use of the described covers, panels, or layers. In addition, while the example provided concerns three compartments for storing medications, the present invention may be configured to accommodate one or more compartment as well as any number of medications in its various embodiments.

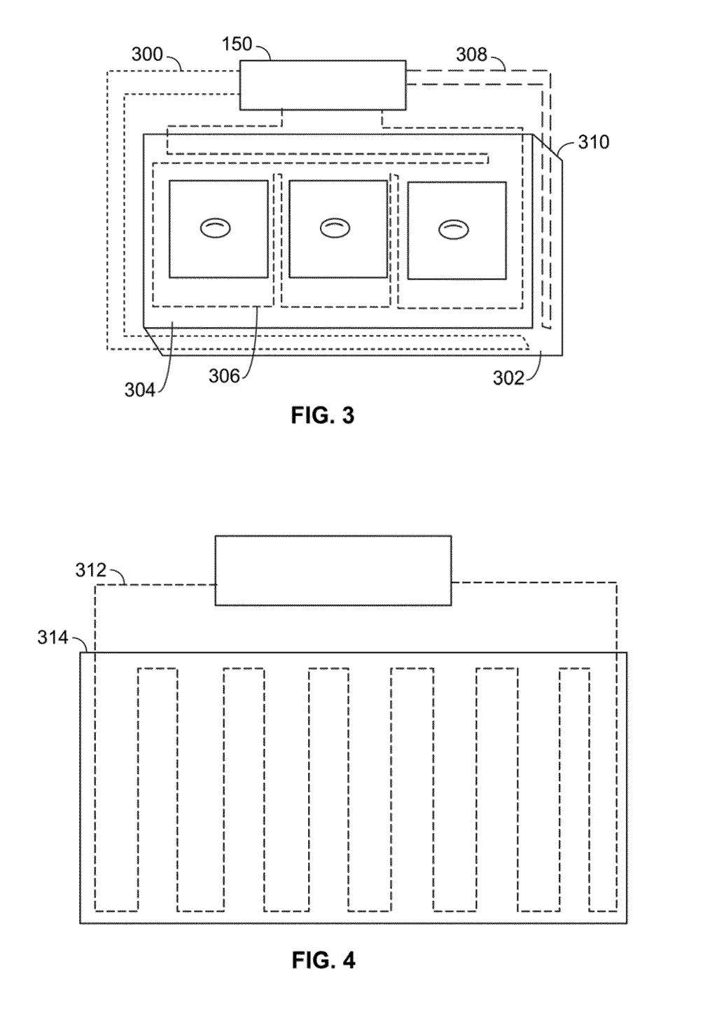

As shown in FIGS. 1 and 2, control unit 150 is also provided. Control unit 150 may be part of container 100. Control unit 150 may also be a separate unit that is in electrical communication with container 100. Control unit 150 may include processor 155 which is configured to operate the device, one or more communication circuits 200 which may be used for short-range communications such as relatively short-range wireless communication protocols including, but not limited to Wi-Fi (e.g., a 802.11 protocol), Bluetooth (registered trademark), high frequency systems (e.g., 900 MHz, 2.4 GHz, and 5.6 GHz communication systems), or other localized wireless communication protocols as well as location detection circuitry such as GPS.

Control 150 may also include a memory 202. Other components may include visual display 204 which may be a display using light emitting diodes, audio component 206, input and output ports 208, power source 210 and clock 212.

As shown in FIG. 2, each of the covers 110-112 includes an electrical circuit 220, 230 and 240. Each electrical circuit has a predetermined resistance which may be the same or different. For example, the resistance of circuit 220 may be different than that of circuit 230 as a result of the overall length of circuit 220 being longer. This results in each compartment having a unique signal, which allows for the processor to identify when a specific compartment has been accessed. In addition, the resistance associated circuit 230 may be different than that of the other circuits as a result of varying the length of the electrical path as a well as width of the path. Using materials having different electrical resistivity may also vary resistance of the circuit. The circuits may be printed directly on the cover or formed in other ways known to those of skill in the art. In addition, the circuits should be designed in such a manner that the removal of the medication results in the breaking of the circuit or creating a discontinuity in the circuit.

In use, as a medication is removed, the circuit is disrupted which enables the circuit to function primarily as a voltage divider. In some embodiments, an input voltage, preferably about a 110 input voltage and more preferably about a 4-6 volt input voltage, is supplied by power source 210 to each circuit by a controller 155.

As a specific example of use, to remove medication 130, protective cover 110 must be physically removed, torn, or altered to provide access to the medication. This, in turn, breaks the track of circuit 220 resulting in a measurable change in output voltage as a result of the overall resistance associated with the device being commensurately lowered by the removal of the resistance associated with circuit 220.

The change in voltage is detected by controller 155 and converted to a value between about 0 and 1020 to provide about five (5) to about 15 bits of resolution and more preferably about ten (10) bits of resolution. As more medication is removed from the corresponding compartments, larger changes in voltage are detected. Controller 155 maps the detected change in output voltage to the number of tablets removed. In addition, in embodiments in which each compartment has a circuit having a predetermined resistance which is different than the other circuits and compartments, the measured change in voltage will also identify the compartment from which the medication was removed.

Determining the compartment used, permits an identification of the exact medication stored in the compartment. This not only allows for the tracking of the number of medications removed, but which mediations were removed as well.

Controller 155 preferably stores a date and time stamp using clock 212 for each removed tablet. Controller 155 may also use communication circuitry and location circuitry 200 to transmit an event code or other communication to a remote computing device for storage and/or display. This communication may also be directed to any interested party such as a doctor, pharmacist, family member, patient, healthcare provider, or pharmacist.

In another embodiment, if the medication is not removed within a pre-determined time, a reminder signal can be sent to a user. The patient's dosing regimen may be programmed directly into the device or stored remotely on a server to be accessed through the Internet. Remote storage of the patient's regimen allows providers to make changes to the regimen, which are propagated to the device in, real-time. If controller 155 senses that the patient has not taken their medication on time, audible and/or visuals indicators can be used to remind the patient to take their medication by visual display 204 or audio component 206. If the patient has still not taken their medication within the time specified by their regimen, electronic messages can be sent to all authorized individuals through a registered account service.

In a further embodiment of the present invention, if there is unused medication, a pharmacy may be notified. In clinical trials, the sponsors of the clinical trial can monitor patient compliance. The inclusion of a circuit assigned to uniquely identify a specific medication may also reduce counterfeiting. As a non-limiting example, a read-only RFID chip can be encoded with a unique key and embedded into the packaging to serve as an indicator of authenticity. If authenticity of the product is questioned, the packaging can be scanned and verified against a database containing legitimate products keys. Alternatively, a unique circuit, conductance and/or resistance may be integrated into the circuit itself that is incorporated into the packaging. This may also act as an identifying fingerprint for the product.

Another embodiment of the present invention includes a medication reminder system wherein the system alerts a patient when it is time to take medication contained in the device. An audible alarm 206 and/or a light 204 can indicate when it is time to take the medication. The patient's dosing regimen may be programmed directly into the device or stored remotely on a server to be accessed through the Internet. If the patient has not taken their medication within the window specified by their regimen an audible reminder can be emitted from the device.

Additionally, a light emitting diode can be used to alert patients who may suffer from hearing impairments. An SMS text message or email may also be sent as a reminder if the patient has not taken their medication within a specified time period.

In a further embodiment, unique signals and/or a voltage may be emitted when at least one compartment cover or wall is deformed or broken. With this embodiment, deformation or breakage may activate controller 155. This embodiment is for those users who are required to take a medication within a fixed timeframe. In this way, a physician can discover errors in the therapy compliance quickly, so that intervention can take place on time.

In another embodiment, the signaling circuit is configured to sense the deformation of the packaging, one or more covers, and/or one or more walls of the device. In a preferred embodiment, the circuit includes a thin film piezoelectric material that uses the piezoelectric effect to measure pressure, acceleration, strain or force by converting, them to an electrical signal. A piezoelectric sensor is capable of generating an electrical charge in response to an external stress. Electrodes placed on the piezoelectric material are used to detect the electrical charge when the piezoelectric material receives an external stress and the amount of the charge is related to the intensity of the stress. This, in turn, may be used by controller 155 to determine if use or tampering has occurred.

In another embodiment, a light or sound signal can be emitted if a product is erroneously taken out. Other possible alarm signals include generating a message on a display that warns the user that the wrong product is being taken. In addition, the device may be programmed to provide instructions to wait for the right time or choose another product according to the prescription.

Preferably the packaging in accordance with some embodiments of the invention is in the form of a blister pack and the products are medications, whereby a pattern is printed on foil that serves as covers 110-112. The foil is used to seal the openings in compartments 102-104 that are formed in film 115 and which house the medication. This packaging is particularly suitable for measuring the therapy compliance of a patient, who is supposed to take medication that has been prescribed by a doctor and/or dispensed by a pharmacist in accordance with a prescribed order and at prescribed time intervals.

Another embodiment of the present invention includes a medication adherence methodology, which measures the change in voltage generated by the removal of a tablet from its compartment. As more tablets are removed from the packaging, the circuit detects a larger net change in voltage. Voltage values can then be mapped to provide a means of determining how many tablets have been removed and how many tablets remain in the packaging. Voltage values can also be mapped to provide a means to identify the specific medication that has been removed and when. This data can be stored locally or transmitted wirelessly to authorized individuals.

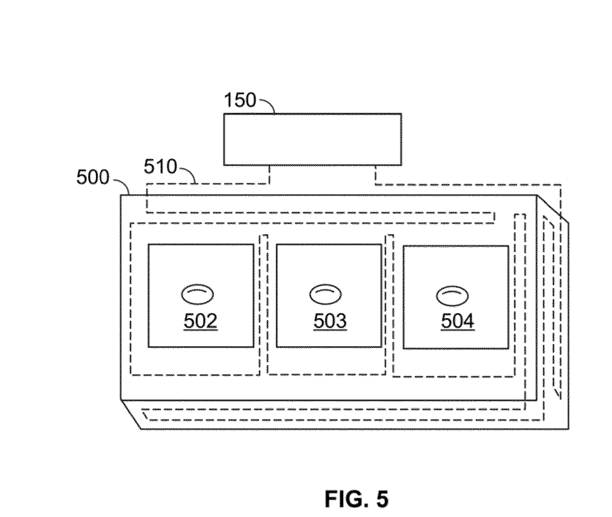

FIGS. 3 and 4 illustrate an embodiment of the present invention intended to deter and detect tampering or accessing the medication through other parts of the device other than through covers 110-112. As shown, opposing surfaces 304 and 314 as well as walls 302 and 310 may contain circuits 300, 306, 308 and 310 which monitor for a physical change in the packaging, resulting from any unauthorized access to the medications other than through covers 110-112. As stated above, the circuits should be designed to cover enough area to create a break in the circuit upon the removal of a medication. As with the above-described embodiments, the break or discontinuity in one of the circuits produces a detectable event such as a change in voltage. In addition, because the circuits may also have predetermined resistances, the device will be able to detect this event and provide notification in a manner described above.

In yet another embodiment, device 500 may include circuit 510. As stated above, circuit 510 should be designed to cover enough area to create a break in the circuit upon the removal of a medication other than through covers 502-504. As with the above-described embodiments, the break or discontinuity in the circuit produces a detectable event such as a predetermined change in voltage, which indicates an event for, which a notification in a manner described above may be provided.

In another embodiment of the invention, the wire circuits described above may be replaced by breakable fiber optics. Accordingly, the controller may be configured to sense the breakage in the fiber and detect the removal of a medication.

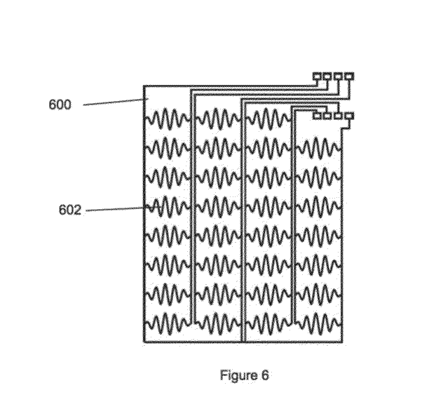

In yet another embodiment, as shown in FIG. 6, the present invention may in the form of a container 600, such as a multi-dose cold seal blister pack. Sinusoidal circuit tracks 602 are positioned over each medication compartment in such a way that become disrupted when a dose is removed. Sinusoidal patterns are used to increase the coverage of each medication compartment which increases the chance of disruption upon dose removal. This increases the specificity of the device by reducing the number of false negatives. The circuit can be deposited onto a variety of substrates including but not limited to adhesive films which can be configured to fit a wide range of different blister packs and medication containers. Circuits can be applied directly to the external surface of the packaging using methods described below or can be generated on an adhesive substrate which is then applied to the medication packaging during manufacture or dispensing. Additionally, circuits can be embedded directly into the medication packaging during manufacturing.

Circuits 602 may be created using a colloidal suspension of silver nanoparticles. The may be applied using an inkjet printer directly onto the medication packaging or onto an adhesive substrate that can later be applied to the packaging. Using a printer to produce the circuit is preferred as it allows more control and is highly reproducible. Printers suitable for application of the circuit include but are not limited to thermal and piezoelectric inkjet printers. Other methods of conductive ink, application may be suitable such as sputter coating and spraying. The circuit may be modified by doping the ink or altering the design in such a way as to allow specific electrical properties to be achieved. For example, applying graphite bridges/segments to increase the overall resistance of the circuit.

The circuits utilize the intrinsic electrical properties of graphite or other conductive inks. In yet another design, the circuit was developed using a mask to spray the circuit pattern onto a paper substrate using conductive graphite spray. Graphite printer inks exist which may allow circuits to be printed directly onto packaging or onto adhesive substrate using an inkjet printer or other means.

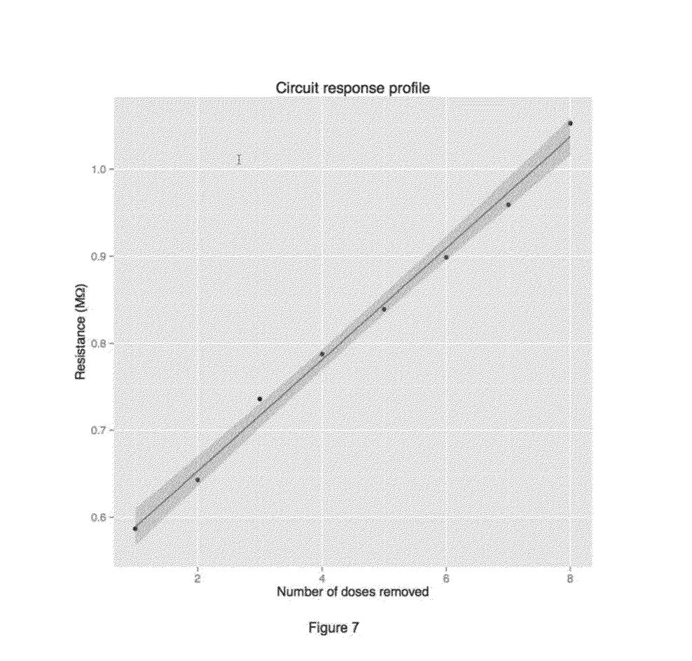

Using the circuit design shown in FIG. 6, several tests were carried out to investigate the circuits response as medications were sequentially removed. The sinusoidal tracks 602 were disrupted and circuit resistance was measured using a digital multimeter. Two experiments were conducted and the average resistance was plotted as a function of removed doses as shown in FIG. 7. The tested circuit demonstrates a linear change in resistance with each dose removed. A linear change response provides a robust signal and is preferred but not required. Any change in resistance whether linear or not that sufficiently generates a signal that can be read by the microcontroller/electronics is suitable. Observed changes in resistance/voltage can be used to detect when a dose was taken, how many doses were/have been taken and how many doses remain within their compartments.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A medication dispenser comprising:
a plurality of compartments for receiving one or more medications;
a circuit associated with each compartment;
said circuit altered by the removal of one or more medications from a compartment.

2. The dispenser of claim 1 wherein said dispenser uses one or more circuits to detect the removal of a medication.

3. The dispenser of claim 1 wherein said circuit is altered by the breaking of an electrical circuit.

4. The dispenser of claim 2 wherein each circuit has the same resistance.

5. The dispenser of chum 2 wherein each circuit has a different resistance.

6. the dispenser of claim 1 further including a processor for monitoring said circuits.

7. The dispenser of claim 1 wherein each compartment has an electrical circuit associated with it and each circuit has a different resistance.

8. The dispenser of claim 1 wherein further including circuits associated with covers for said compartments and at least one circuit associated with each of said compartments.

9. A method of monitoring the usage of a medication comprising:
providing a container having a plurality of compartments for housing one or more medications;
providing an electrical circuit associated with each compartment; and
monitoring the removal of a medication from a compartment by monitoring the electrical circuit for an alteration in the circuit caused by the removal of the medication.

10. The method of claim 9 wherein said alteration of said electrical circuit is detected by detecting an increase in voltage.

11. The method of claim 10 wherein said alteration changes a monitored resistance.

12. The method of claim 11 wherein said alteration changes a monitored resistance and wherein each circuit has a different resistance associated with it.

13. A method of monitoring the removal of a medication from a container comprising:
providing a container having a plurality of compartments for housing one or more individual medications;
providing a unique signal associated with each compartment; and
monitoring the removal of a medication from a compartment by monitoring the signal for an alteration in the signal caused by the removal of the medication.

14. The method of claim 13 wherein said signal is an electrical signal.

15. The method of claim 13 wherein a message is generated upon detection Of an alteration in the signal caused by the removal of the medication.

16. The dispenser of claim 1 further including a timer in communication with said controller, said timer tracks elapsed time from a medication being removed to identify when a subsequent medication is to be removed, and wherein said timer is initially activated in response to detecting a first medication being removed.

17. The method of claim 13 wherein said unique signal is associated with a predetermined individual medication and said predetermined individual medication is indicated as removed when said unique signal is detected.

18. The method of claim 17 further including a timer in communication with a controller, said timer tracks elapsed time from when a first predetermined individual medication is removed as a result of detecting said unique signal associated said first predetermined individual medication to identify when a subsequent predetermined medication is to be removed, and wherein said timer is initially activated in response to detecting a first medication being removed.

19. The dispenser of claim I wherein said dispenser includes circuit that uniquely identities the dispenser.
